(19) United States
(12) Patent Application Publication
(10) Pub. No.: US 2008/0181999 A1
(43) Pub. Date: Jul. 31, 2008

(54) Water Leaching Method to Extract Oil Plant Products

(76) Inventor: Lanqin Yang, Fujian (CN)

Correspondence Address: Dr. BANGER SHIA, 102 Lindencrest Ct., Sugar Land, TX, 77479-5201, US

(21) Appl. No.: 11/910,264

(22) PCT Filed: Dec. 13, 2005
(86) PCT No.: PCT/CN2005/002174

§ 371 Date: Sep. 29, 2007

(51) Int. Cl. C11B 1/10

(52) U.S. Cl. 426/417

(57) ABSTRACT

A method of water leaching to extract plant oil, plant crude protein, and plant fiber includes steps of preparation of oil plant, rinse, stripping and crushing, soaking, and pumped with water to a centrifuge for separating products of plant oil, crude protein, and plant fiber. The process is essentially provided for crops including soybean, peanut, sesame, oiltea camellia, perillae fructus, sea buckthorn, and safflowers to effectively improve oil yield and quality, and better separate oil from protein, and prevent contamination from chemical solvents for maintaining safe and healthy diet for the people.

### BACKGROUND OF THE INVENTION

(a) Field of the Invention

The present invention is related to a water leaching method to extract oil plant products, extraction method, and more particularly to one that uses water leaching to extract plant oil, plant crude protein, and plant fiber from crops including soybean, peanut, sesames, oiltea camellia, perillae fructus, sea buckthorn, and safflowers.

(b) Description of the Prior Art

For long time, the process industry of agricultural products in China has been significant falling behind that in advanced countries. Since the reformation, department of food provisions has introduced from advanced countries technology and equipment for processing food provisions and the level of the process industry of food provisions has been improved. However, the process industry of food provisions in general is straggling and the business scale remains small, processing plants scattering around the country, and poor equipped with most of the plants are confined to primary process. The straggling situation not only causes the resources of agricultural products to prevent justifying and full development but also leads to comparatively lower quantity and quality of crops in weakening their market competition strength.

China has abundant oil plant resources with its production of soybean and peanut ranked at the top of the world. This provides a good reason for full exploitation of such a unique advantage by heading for building up agriculture led by technology to further dig out potentials of edible oil to put them into refine process for reinforcing the competition strength of domestic edible oil products.

Taking the soybean fro example, it is an important quality oil source and also a very important source of quality protein. It takes only the modem technology to fully extract soybean oil from soybean without destroying proteins contained in soybean. In other words, the basic purpose is to increase oil yield while fully taking advantage of soybean protein. Similar to the soybean that can be fully merchandized, peanut oil and other oil plants can be extracted using modern technology for reasonable development to take advantage of essential compositions in those plants.

Although there are many plant oil production plants in China, the use of oil plant, particularly the plant protein, is not satisfactory as desired due to limited production technology.

Domestic peanut oil extraction plants prefer using the pressing method; that is, applying physical pressure to directly separate the oil from the plant without adding into any chemical additive. The pressing method is safe, healthy, and free of contamination; however it suffers low yield, fair quality, and denatured protein in the peanut. Besides, the resultant grain cake from the pressing process is a great waste of the protein resource because it can be best used as feeds or fertilizer.

Most of the domestic soybean extraction plants use the chemical solvent leaching method, a method involving the work principle of taking advantage of the fact that the solubility of a chemical solvent varies depending on the substance to be dissolved. Compositions in a solid substance are separated from one another in the solvent method, a process also known as ‘extraction’. No. 6 oil extraction solvent, generally known as the #6 light gasoline is the organic solvent used in the extraction process. Crushed plant is fully mixed with the organic solvent before the extraction. The solvent permeates into the cells through the cell walls of the plant while the oil enters from the cell into the solvent. With uninterrupted supply of fresh solvent, oil in the plant is practically diffused from the cells to separate the oil from the protein. The soybean oil availed from using the extraction method has high yield of oil, lower labor intensity, better work environment, and better quality of the dried grain.

Thought the solvent method increases oil yield and reduces denatured protein when compared with the pressing method, it is found with defectives including an inherited flaw of failure in removing most of the solvent in the course of production, too many work stations, and lengthy processes, excessive consumption of energy (it takes five stages of extraction) resulting in higher level of residual solvent to compromise food safety and health, and higher production cost. Residual chemical solvent in the oil and the dried grain would certainly affect their quality while creating problems of food safety and health, environmental pollution, and production safety that are beyond solutions.

### SUMMARY OF THE INVENTION

The primary purpose of the present invention is to provide a process to extract plant oil, plant crude protein, and plant fiber using a water soaking method to correct the problems of length process and solvent contamination found with the conventional method.

To achieve the purpose, the present invention includes the following steps:
(1) Preparing raw material: an excellent oil plant is selected for extraction of its oil;
(2) Rinsing: the raw material is rinsed by manual or by machine;
(3) Stripping & Crushing: a dedicated machine is operated to strip and crush the oil plant;
(4) Soaking: the stripped and crushed oil plant is fully soaked in water; and
(5) Separating: the soaked oil plant is pumped with water to a centrifuge to separate plant oil, plant crude protein, and plant fiber.

In step (4), ultrasonic is used at the same time; the temperature of the raw material is controlled within the range of 30 degree C.˜55.5 degree C.; and the length of the soaking is controlled with a range of 2˜8 hours in step (4) of soaking process.

The finished products of plant oil, plant crude protein, and plant fiber extracted from using the soaking method of the present invention is further put into Step (6) for concentration and dehydration, wherein osmosis and ultra-filtration are performed and the water produced is refilled into a soaking vessel for reuse.

Advantages of the present invention includes elimination of possible contamination by chemical solvent and hazards of chemical solvent to protect diet health; and use of water as the solvent also simplifies the process to shorten process flow and reduce energy consumption thus to realize commercial production and warrant production safety. To achieve sustainable development and enhance protection for the environment, the present invention allows full exploitation of the raw material and complete a completion reclaim of protein, sugar, and fiber by means of the existing osmosis and ultra-filtration processes to warrant clean production for realizing the ultimate goal of pollution free effluence.

### BRIEF DESCRIPTION OF THE DRAWINGS

FIG. 1 is a flow chart showing a production process of the present invention.

### DETAILED DESCRIPTION OF THE PREFERRED EMBODIMENTS

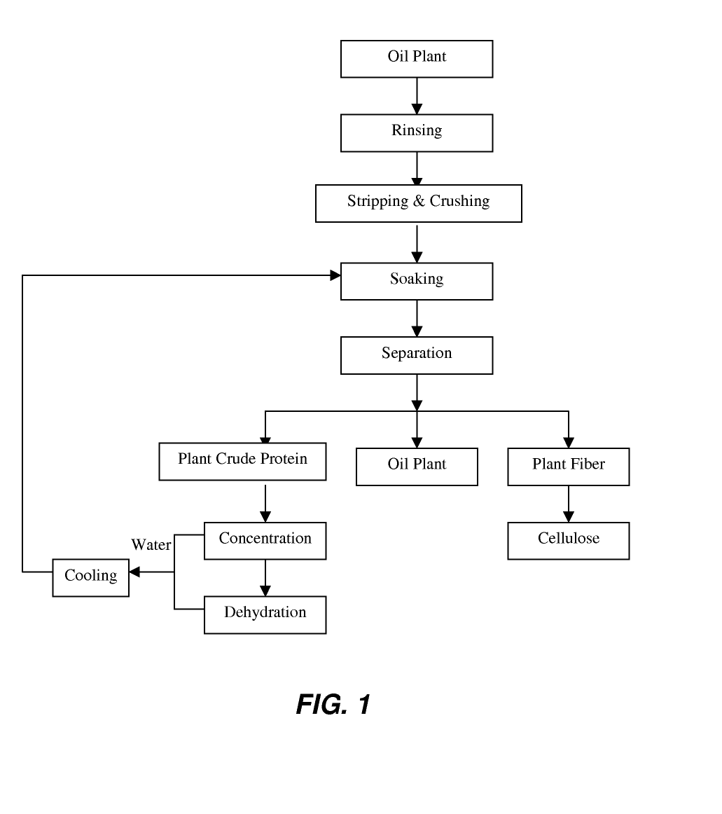

Referring to FIG. 1, a water leaching method to extract plant oil, plant crude protein, and plant fiber including the following steps:

(1) Preparing the raw material: soybean, peanut or other quality oil plant is selected as the raw material for oil extraction since the plant oil proves to be harmless against human health thus to warrant diet health.

(2) Rinsing: the select oil plant is rinsed by manual or by machine while the existing machine may be used to rinse the selected soybean or peanut.

(3) Stripping and Crushing: a dedicated machine is operated to strip and crush the selected soybean or peanut.

(4) Soaking: the stripped and crushed soybean or peanut is put in water for total soaking; meanwhile, ultrasonic is used to open up cell wall of the oil plant to release oil and separate oil from original active protein. A consistent temperature shall be maintained in the soaking process and it is found that a range of 30 degree to 55.5 degree C. is preferred and that the optimal effect of soaking is achieved at 50 degree C. after many times of tests and analyses. Protein in the soybean or the peanut is vulnerable to be denatured if the soaking temperature is higher the range preferred; or lower oil yield, lower. A temperature control device is disposed for controlling the soaking temperature within the range. The soaking process takes two hours up to eight hours. If longer, the work efficiency gets too low; and shorter, the oil yield is too low. The preferred length of the soaking process is six hours.

(5) Separating: the soaked soybean or peanut is pumped with water to a centrifuge to separate three products of plant oil, plant crude protein, and plant fiber. The plant oil after refinery process becomes edible oil; and the plant crude protein and the plant fiber are further processed into other side products such as sugar can be extracted from the plant crude protein after osmosis and ultra-filtration processes and the plant fiber, cellulose.

(6) Reuse of water: the water produced from concentration and dehydration using osmosis and ultra-filtration methods on the separated plant crude protein is directly refilled into the soaking process for reuse to save water consumption and reduce production cost without effluence and resulted pollution to help protect the environment.

The present invention is essentially applied for oil extraction with soybean, peanut, sesame, oiltea camellia, perillae fructus, sea buckthorn, and safflowers. Wherein the oil extraction from soybean involves the most complicated process, therefore, if it works fine with the soybean, it usually works with any other oil plants. Incorporated with the technology of using ultrasonic to break up cell walls and the water as a solvent to leach, the present invention is applied in industrialized production technology under lower temperature conditions effectively separate plant oil, plant crude oil, and plant fiber out of oil plant while effectively solving the problems of residual chemical solvent and side products with little value, thus to realize high yield production, top quality plant oil, and high activity plant crude protein.

Furthermore, upon extracting the plant oil, the present invention also by taking the issue of use the plant crude protein into consideration by delivering quality and contamination free plant active protein by separating the plant protein from oil in water at lower temperature without contamination thus to maintain high activity (i.e., high PSI) of the protein allows full utilization of oil plant resources, and provide a sound and complete industrial chain for the production of plant oil to present a new channel for in-depth development and expansion of oil plant.

I claim:

1. A water leaching method to extract plant oil, plant crude protein, and plant fiber comprising the following steps:
(1) Preparing the raw material: a quality oil plant is selected as the raw material for oil extraction;
(2) Rinsing: the select oil plant is rinsed by manual or by machine;
(3) Stripping and Crushing: a dedicated machine is operated to strip and crush the selected oil plant;
(4) Soaking: the stripped and crushed soybean or peanut is put in water for total soaking, and ultrasonic is sued; and
(5) Separating: the soaked oil plant is pumped with water to a centrifuge to separate plant oil, plant crude protein, and plant fiber.

2. The water leaching method to extract plant oil, plant crude protein, and plant fiber as claimed in claim 1, wherein the temperature of water used in Step 4 is controlled within a range of 30 degree C. to 55.5 degree C.

3. The water leaching method to extract plant oil, plant crude protein, and plant fiber as claimed in claim 1, wherein the temperature of water used in Step 4 is controlled at 50 degree C.

4. The water leaching method to extract plant oil, plant crude protein, and plant fiber as claimed in claim 1, wherein the soaking process in Step 4 is controlled within a range of two up to eight hours.

5. The water leaching method to extract plant oil, plant crude protein, and plant fiber as claimed in claim 1, wherein the soaking process in Step 4 is controlled at a time length of six hours.

6. The water leaching method to extract plant oil, plant crude protein, and plant fiber as claimed in claim 1, wherein a sixth step is further provided to dehydrate the separated plant crude protein using osmosis and ultra-filtration processes and the resulted water is directly refilled into a soaking vessel for reuse in Step (4).
